(19) United States
(12) Patent Application Publication
(10) Pub. No.: US 2014/0258142 A1
(43) Pub. Date: Sep. 11, 2014

(54) BATTERY LEASING SYSTEM

(71) Applicant: SEMICONDUCTOR ENERGY LABORATORY CO. LTD., Atsugi-shi (JP)

(72) Inventor: Shunpei YAMAZAKI, Tokyo (JP)

(73) Assignee: SEMICONDUCTOR ENERGY LABORATORY CO. LTD., Atsugi-shi (JP)

(21) Appl. No.: 14/197,463

(22) Filed: Mar. 5, 2014

(30) Foreign Application Priority Data
Mar. 8, 2013 (JP) 2013-046500

(51) Int. Cl. G06Q 30/06; H02J 7/00

(52) U.S. Cl. CPC G06Q 30/0645; H02J 7/00
USPC 705/307

(57) ABSTRACT

To provide a battery leasing system with which an initial investment for a battery installed inside or outside a home of a user can be reduced, ideally to zero. To provide a leasing system in which the battery is installed at the user's home with an initial investment of a leasing company and the user pays a predetermined charge to the leasing company. The amount of the predetermined charge collected from the user is a portion of money saved by energy conservation. This leasing system can easily increase homes with the battery capable of being as an emergency power source.

### BACKGROUND OF THE INVENTION

1. Field of the Invention

The present invention relates to a battery leasing system (or battery rental system), namely, a business model for leasing a battery.

2. Description of the Related Art

With the depletion of fossil fuels, the unit price of electric power is assumed to rise in the future around the world. Although the unit price of electric power can be set low if the reliance on nuclear power generation is increased, many countries tend to reduce their reliance on nuclear power generation because of concerns about accidents or the like. The number of countries relying on nuclear power generation has been decreasing.

Further, there are many users (e.g. general consumers) who purchase a rechargeable battery and install it outside their homes in preparation for power outages or disasters.

To determine the purchase of the battery, the users estimate the amount of money which is to be saved by energy conservation (savings) as a result of purchasing the battery and installing it inside or outside their homes, and then, the users judge the profitability of the battery from the durable years, the initial investment cost, the payback period, and the like of the battery.

However, in the case of installing the battery inside or outside home, the users need a high initial investment (the amount of money for purchasing the battery itself and installing the battery), though it depends on the charge capacity of the battery. Because of this high initial investment, the users may judge the battery unprofitable, which is one of the main factors preventing their purchase of the battery. Further, it is difficult for the users to judge whether the battery is profitable because of difficulty in predicting ten or more years ahead.

Patent Document 1 describes a leasing-type solar photovoltaic system for increasing the use of solar photovoltaic systems.

### REFERENCE

### Patent Document

[Patent Document 1] Japanese Published Patent Application No. 2012-248642

### SUMMARY OF THE INVENTION

It is an object to provide a battery leasing system in which an initial investment can be reduced, ideally to zero, for a battery installed inside or outside a user's house.

It is another object to provide a leasing system in which a battery is installed at a user's home with an initial investment from a leasing company and the user pays a predetermined charge to the leasing company.

Money is saved by energy conservation with the use of the battery, and the leasing company collects a portion of the money from the user as the predetermined charge.

The user makes a contract with an electric power company for the supply of electric power. As a service, the electric power company offers a contract in which the unit price of electric power varies according to a time period. Note that the unit price of electric power refers to the price of electric power per unit (the price of electric energy per kilowatt-hour). The user makes such a contract with the electric power company and makes good use of the unit prices of electric power that are different depending on a time period, thereby obtaining money saved by energy conservation. For example, the battery is charged in a time period in which the unit price of electric power is the lowest (e.g., the night time), and electric power to be consumed in the home in a time period in which the unit price of electric power is high (the day time) is supplied only from the battery. In that case, a larger difference is generated (more money is saved by energy conservation) as a larger amount of electric power is consumed in the day time. The leasing company collects a part of the difference as a predetermined charge from the user.

The present invention disclosed in this specification is composed of a system for leasing a battery in which a user has a supply of electric power from an electric power company at unit prices of electric power that are different between a first time period and a second time period, including, in the second time period in which a unit price of electric power is lower than a unit price of electric power in the first time period, charging the battery by electric power supplied from the electric power company, allowing the user to consume electric power supplied only from the battery in the first time period, calculating (calculating by the leasing company or by a computer) a difference between a predicted first electricity charge for a case where the battery leasing system is not employed and a second electricity charge that is actually paid to the electric power company by the user, calculating (calculating by the leasing company or by a computer) a charge that is commensurate with the leasing company from the difference between the first electricity charge and the second electricity charge, and requesting the user pay the charge to the leasing company.

The leasing company not only lends the battery to the user but also performs the maintenance on the battery.

The present invention disclosed in this specification is composed of a system for leasing a battery including maintenance in which a user has a supply of electric power from an electric power company at unit prices of electric power that are different between a first time period and a second time period, including, in the second time period in which a unit price of electric power is lower than a unit price of electric power in the first time period, charging the battery by electric power supplied from the electric power company, allowing the user to consume electric power supplied only from the battery in the first time period, calculating (calculating by the leasing company or by a computer) a difference between a predicted first electricity charge for a case where the battery leasing system is not employed and a second electricity charge that is actually paid to the electric power company by the user, calculating (calculating by the leasing company or by a computer) a first charge that is commensurate with the leasing company from the difference between the first electricity charge and the second electricity charge, performing a maintenance on the battery by the leasing company, calculating (calculating by the leasing company or by a computer) a second charge that is commensurate with the leasing company, and requesting the user pay the first charge and the second charge to the leasing company.

Note that in the above-described structure, the frequency of the maintenance is reduced as much as possible, i.e., approximately once every year or once every several years. For example, when there are 100 or more battery users in a certain area, the leasing company visits the users in the area concurrently and performs maintenance one time for each. In that case, the leasing company can perform maintenance efficiently, and the cost of the maintenance (second charge) can be reduced accordingly.

The leasing company can collect the cost of maintenance from the user every time the maintenance is performed. The maintenance cost can be reduced to a minimum, as the number of times of maintenance is smaller.

In the case where the leasing company leases a battery and a user returns the battery after using it for a certain period of time, the leasing company can rent the battery to another user, which reduces the initial investment of the leasing company. When the company rents a user a used battery, not a new battery, the company can be referred to as a rental company, not a leasing company. Even the used battery has substantially the same performance (e.g., charge capacity) as a new one.

Note that the battery that the leasing company lends is a lithium-ion secondary battery having high safety and capable of being used for 20 years or longer. Even when the battery is repeatedly charged and discharged every day, decrease in capacity due to degradation hardly occurs. In the case where the battery deteriorates, the battery can be recovered from its deteriorating state by the maintenance performed once every year or once every several years.

In the above-described structure, as the maintenance of the battery, supplying of a current reverse to a charging current is performed momentarily (for longer than or equal to 0.1 second and shorter than or equal to 3 minutes, typically longer than or equal to 3 seconds and shorter than or equal to 30 seconds) once or more than once in charging. In this specification, supplying a current reverse to a charging current momentarily in this manner is referred to as “supplying an inversion pulse current”. Intervals at which the inversion pulse current is supplied and the intensity of the inversion pulse current are set as appropriate.

A battery which is not degraded for a long period of time in principle can be obtained by supplying the inversion pulse current to the battery as appropriate in charging. Such maintenance performed on the battery as appropriate makes it possible to construct a battery leasing system.

The battery can be repeatedly charged and discharged for a long period of time. The used battery returned from the user is subjected to degradation reduction treatment (e.g., supplying the inversion pulse current or treatment using special equipment or a special device which is difficult for general consumers to purchase and possess), whereby the battery can be lent to another user. Such degradation reduction treatment (also referred to as maintenance) makes it possible to reuse the battery and construct a battery rental system.

Further, the user can use the same battery for a long period of time by the maintenance repeatedly performed until a profit is yielded by the use of the battery, without judging the profitability of the battery. Thus, the installation of batteries in homes can be popularized easily.

In the case where the user lives in a home that consumes only electricity as a heat source to reduce the payment of the public utility charge (gas or electricity), the home consumes a larger amount of electric power. Accordingly, more money can be saved by energy conservation through the battery leasing system. Moreover, leasing the battery to the user whose home consumes only electricity as a heat source can reduce the risk of a power failure or the like.

Another advantage is given in the case where the user owns an electric car. When the battery (leased battery) is charged in a time period in which the unit price of electric power is the lowest, and further, the electric car is charged using the battery, the electric car can be charged at low cost without concern about the time period. Further, the battery (leased battery) can be supplied with a part of electric power produced by taking the electric car, so that electric power can be utilized effectively.

It is possible to provide a battery leasing system in which an initial investment can be reduced, ideally to zero, for a battery installed inside or outside a user's home.

Further, by enabling reuse of the battery for a long period of time, the need for destroying the battery or decomposing the battery to be recycled can be eliminated. Thus, the battery leasing system can contribute to the conservation of environment by preventing the destruction and the decomposition of the battery and allowing the battery to be reused.

Furthermore, the installation of batteries in homes can be easily popularized. When the batteries are installed in many homes and electric power to be consumed in the day time is supplied from the batteries, electric-load leveling can be promoted. The electric-load leveling is aimed at spreading a load by providing a battery system for many homes and the like to improve the electric circumstances of a region.

### BRIEF DESCRIPTION OF THE DRAWINGS

FIG. 1A is a schematic view illustrating a leasing system according to one embodiment of the present invention, FIG. 1B shows a state in the night time or the like, and FIG. 1C shows a state in the day time or the like.

FIG. 2 is a flowchart showing one embodiment of the present invention.

FIG. 3 is a block diagram illustrating one embodiment of the present invention.

FIGS. 4A and 4B are conceptual diagrams illustrating a state where a lithium-ion secondary battery is charged.

FIGS. 5A and 5B are conceptual diagrams illustrating a state where a lithium-ion secondary battery is discharged.

FIG. 6 is a diagram illustrating the relation between the potentials of a positive electrode and a negative electrode.

FIGS. 7A and 7B illustrate one example of a method for performing maintenance on a battery.

### DETAILED DESCRIPTION OF THE INVENTION

Embodiments of the present invention will be described below in detail with reference to the drawings. However, the present invention is not limited to the description below, and it is easily understood by those skilled in the art that modes and details disclosed herein can be modified in various ways. Further, the present invention is not construed as being limited to description of the embodiments and the examples.

### Embodiment 1

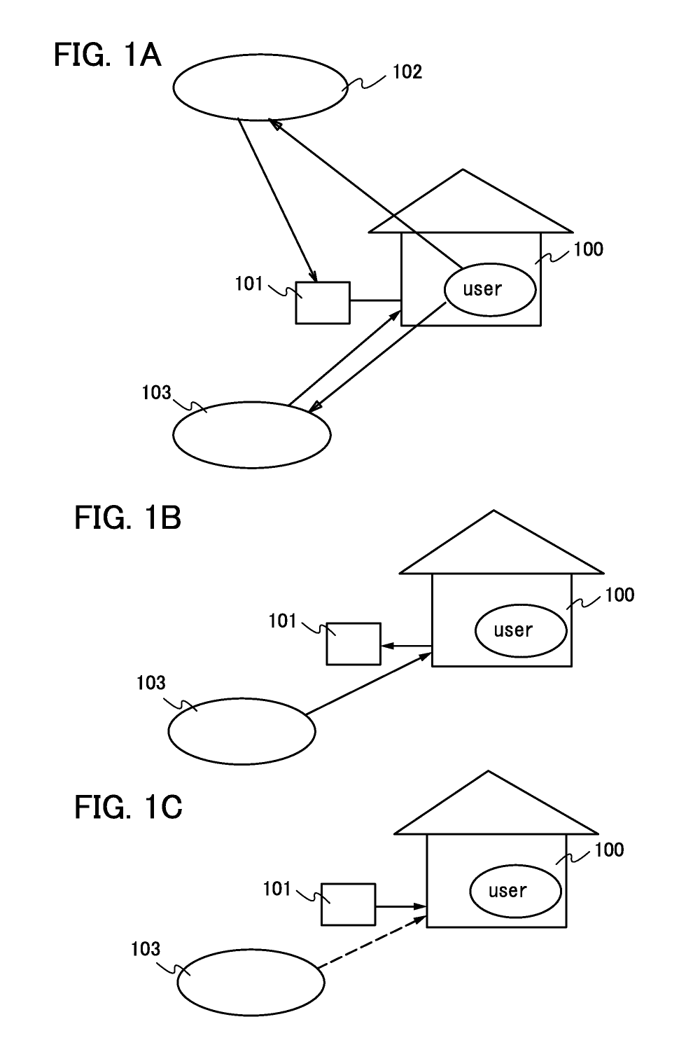

Elements of a battery leasing system are described below with reference to FIGS. 1A to 1C as an example.

As shown in FIG. 1A, a battery leasing system according to one embodiment of the present invention includes a user, a house 100 of the user, a battery 101 installed outside (or inside) the house, a leasing company 102 that leases the battery 101 to the user, and an electric power company 103.

A distribution board (not shown in FIGS. 1A to 1C) provided for the house 100 is electrically connected to the battery 101. The distribution board refers to a box in which a breaker such as an earth leakage circuit breaker, an electricity meter, and a control device such as a remote control relay or a timer are placed. The electricity meter is not limited to an induction-type electricity meter that measures electric power in analog form. The electricity meter may be a next-generation electricity meter (what is called a smart meter) that measures electric power in digital form and has a communication function. In charging the battery 101, electric power from the electric power company 103 is supplied to the battery 101 through the distribution board.

The user makes a contract with the electric power company 103 for the supply of electric power in exchange of paying, to the electric power company 103, a charge (electricity charge) corresponding to the amount of consumed electric power. The electric power company 103 carries out a measurement of the amount of consumed electric power using an electricity meter placed in the distribution board or the like and collects from the user the electricity charge in compensation for the amount of electric power consumed.

Further, the user pays the leasing company 102 a lease charge in compensation for the lease of the battery. That is, the user pays a lease charge, and the battery 101 is leased to the user from the leasing company 102 and provided for the house 100 of the user. Thus, the user does not need to pay money for purchasing the battery 101, thereby reducing an initial investment.

Further, a savings is obtained from the difference between unit prices of electric power depending on a time period, and a part of the savings is paid as a lease charge, which means that the lease charge is not fixed but proportional to the savings.

Specifically, the user makes a contract with the electric power company for the supply of electric power at unit prices of electric power that are different according to a time period. Then, a savings is obtained from the difference between the unit prices of electric power that are different according to a time period, and a part of the savings is determined as a lease charge and collected from the user.

For example, the battery 101 is charged in a time period in which the unit price of electric power is the lowest (e.g., the night time) as shown in FIG. 1B, whereas electric power to be consumed by the house 100 is supplied only from the battery 101 in a time period in which the unit price of electric power is higher (e.g., the day time) as shown in FIG. 1C. Thus, the user that owns the house 100 with the leased battery 101 can pay a charge at the lowest unit price of electric power to the electric power company 103 regardless of time periods.

Therefore, it is enough that the battery has charge capacity to provide electric power to be used in a time period in which the unit price of electric power is high. The operation of the battery is stopped in the time period in which the unit price of electric power is the lowest, except time for charging one time. Note that in the case where a power failure occurs in the time period in which the unit price of electric power is the lowest, the battery can be used as an emergency power source.

Further, in the case where the amount of electric power consumed by the battery is small in the time period shown in FIG. 1C in which the unit price of electric power is high (the day time), the remaining electric power can be used on the next day. Thus, just one charging every several days is enough.

The leasing company 102 calculates a predicted electricity charge which is to be paid to the electric power company 103 on the assumption that the user makes a contract with the electric power company 103 for a usual fixed unit price of electric power that does not vary according to a time period. On the basis of the predicted electricity charge, the leasing company 102 regularly demands the user to pay a part of the difference between the predicted electricity charge and the actual electricity charge, specifically 30 percent of the difference. The predicted electricity charge can be simply calculated using the total amount of electric power supplied from the battery 101 to the house 100 and the usual unit price of electric power.

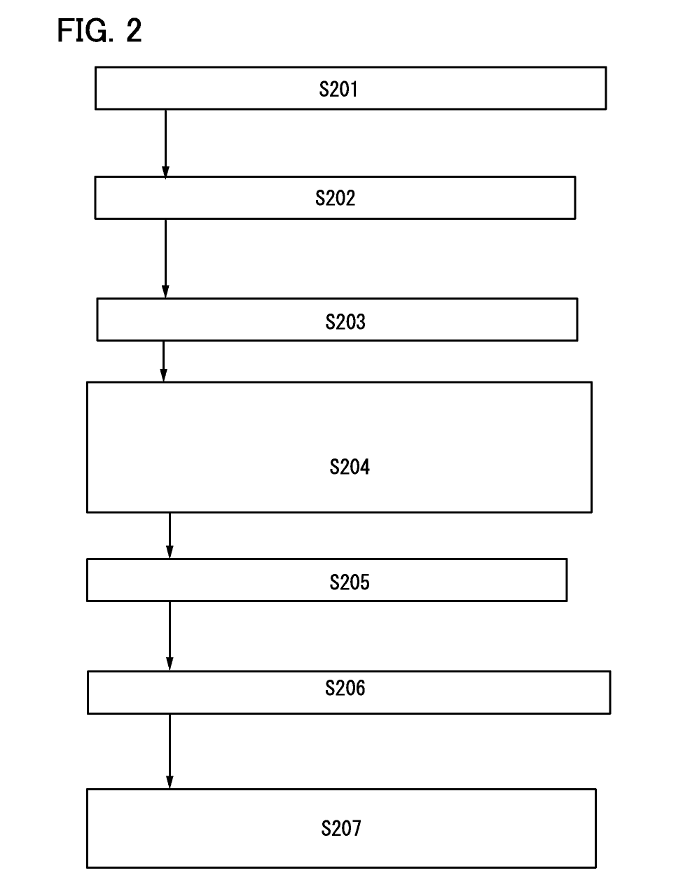

FIG. 2 is a flow chart of a battery leasing system according to one embodiment of the present invention.

First, a user requests the leasing company 102 to lease the battery 101 (S201).

Then, the battery 101 is installed at the house 100 (S202). Note that the battery 101 may be installed by the user or by the leasing company as a free service. In the case where the battery 101 is installed by the leasing company as a free service, the initial cost to the user is further reduced. Although the battery 101 may be installed inside the house 100, the battery 101 is set outside the house 100 in this embodiment because it is the leasing company to perform the maintenance of the battery 101.

The battery 101 is a lithium-ion secondary battery having high safety capable of being used for 20 years or longer. Even when the battery is repeatedly charged and discharged every day, decrease in capacity due to degradation hardly occurs. In the case where the battery deteriorates, the battery can be recovered from its deteriorating state by the maintenance performed once every year or once every several years.

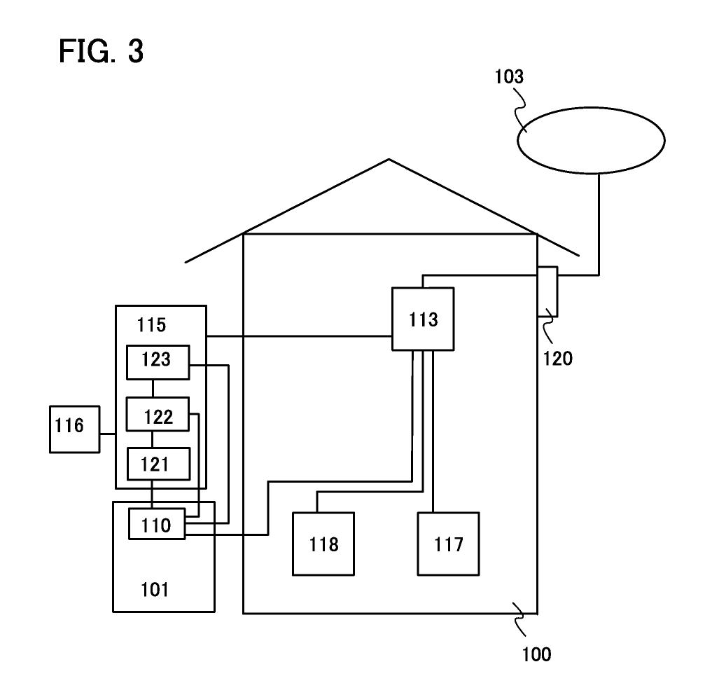

FIG. 3 shows an example of a block diagram illustrating the case where the battery 101 is installed outside the house 100.

As shown in FIG. 3, the battery 101 is installed outside the house 100. The battery 101 is provided with a control device 110. The control device 110 is electrically connected, via wirings, to a distribution board 113, a power storage controller (also referred to as a control device) 115, and an indicator 116.

Power is supplied from a commercial power source of the electric power company 103 to the distribution board 113 through a service wire mounting portion 120. Moreover, power is supplied from the battery 101 and the commercial power source to the distribution board 113. Power supplied to the distribution board 113 is supplied to a general load 117 and a high power load 118 through an outlet (not shown).

The general load 117 is, for example, an electrical device such as a TV or a personal computer. The high power load 118 is, for example, an electrical device such as a microwave, a refrigerator, or an air conditioner.

The power storage controller 115 includes a measuring portion 121, a predicting portion 122, and a planning portion 123. The measuring portion 121 has a function of measuring the amount of power consumed by the general load 117 and the high power load 118 during a day (for example, from midnight to midnight). The measuring portion 121 also has a function of measuring the amount of power supplied from the battery 101 and the amount of power supplied from the commercial power source.

The indicator 116 can show the amount of power consumed by the general load 117 and the high power load 118 that is measured by the measuring portion 121. Further, when the distribution board 113 is a smart meter having a communication function, the amount of power consumed can be checked via the communication.

The power storage controller 115 determines whether to supply power from the battery 101 to the general load 117 and the high power load 118 or supply power from the commercial power source to the general load 117 and the high power load 118, between time periods in which the unit prices of electric power are different. Note that when the supply of power from the commercial power source is stopped or suppressed because of a power failure, for example, the power storage controller 115 supplies power from the battery 101 to the general load 117 and the high power load 118 regardless of the time periods.

In this embodiment, by the determination with the power storage controller 115, the battery 101 is charged in a time period A in which the unit price of electric power is low (S203).

Further, control is performed by the power storage controller 115 so that power is supplied only from the battery 101 to the general load 117 and the high power load 118 in a time period B in which the unit price of electric power is high. Power is supplied from the battery charged in the time period A and consumed in the time period B in which the unit price of electric power is higher than the unit price of electric power in the time period A (S204).

The predicting portion 122 includes a computer or the like and calculates an electricity charge α on the basis of the amount of electric power consumed by the general load 117 and the high power load 118 during the time period B in which the unit price of electric power is high (S205). The power supplied from the battery charged in the time period A is consumed by the general load 117 and the high power load 118 in the time period B in which the unit price of power is high. Thus, the low unit price in the time period A is used to calculate the electricity charge α.

Further, the predict portion 122 calculates an electricity charge β on the basis of the amount of electric power consumed by the general load 117 and the high power load 118 during the time period B in which the unit price of electric power is high. The usual unit price is used to calculate the electricity charge β. In this manner, a predicted electricity charge β is calculated (S206).

A savings corresponds to the difference obtained by subtracting the electricity charge α from the electricity charge β. The user pays a part of the difference to the leasing company 102 (S207).

These data calculated in the predicting portion 122 are displayed on the indicator 116. Note that the difference is calculated every day, and the sum of the differences displayed on the indicator 116 is checked by a staff member of the leasing company 102 every month or every year, and the user is charged payment for the lease. Further, the following system may be applied for automation: a communication function is provided for the power storage controller 115, and data calculated in the predicting portion 122 is communicated to the leasing company 102 every month or every year.

With the above-described battery leasing system, an initial investment when the battery 101 is installed outside the house 100 can be reduced, ideally to zero. The leasing company needs to collect the initial investment for a long period of time; however, the larger the number of the leased batteries is, the higher profit the leasing company can be earned.

Further, the predicting portion 122 may have a function of predicting the demanded power to be consumed by the general load 117 and the high power load 118 during the next day. The planning portion 123 includes a computer, a timer, or the like and has a function of making a charge and discharge plan or the like of the battery 101 on the basis of the demanded power predicted by the predicting portion 122. With the planning portion 123, when the amount of power consumed by the battery is small, the remaining power can be used on the next day. Thus, just one charging every several days is enough. The lifetime of the battery depends on how many times the battery is charged repeatedly. Thus, it is preferable that a time period between the latest charging and the next charging be long, because the lifetime of the battery is extended accordingly.

Further, the maintenance of the battery can extend the lifetime of the battery. Thus, the used battery which is returned from the user can be lent to a next user, whereby the leasing company can easily recover the initial investment. Further, the battery can be lent to a next user who intends to use the battery in a short period of time of 10 years or less. Therefore, the battery can also be lent to a user who wants to introduce a battery by way of trial. In the case where the battery is reused, the system can be referred to as a battery rental system.

In a conventional system, once a battery is purchased and the equipment for the battery is installed, a return is not accepted; thus, a person who purchased the battery needs to pay all the cost for the purchase and the installation. Further, most of the consumers may decide not to buy a battery because of the following reason. The lifetime of a house is said to be 30 years, and during the years, members of a family may increase or decrease, for example. There might be a merit in purchasing a battery while the family has many minors. However, after they grow up and leave home, the cost of the battery cannot be recovered in some cases. In contrast, when the above-described battery leasing system is used, the leasing company leases a battery to a user and installs or removes the battery as a service. In that case, because the burden on the user can be reduced, the popularization of installing batteries in homes can be promoted.

In this embodiment, a house owned by one user is given as example. However, this embodiment is not limited thereto in particular. Apartments, buildings owned by a company, or the like can also be applied. Further, this embodiment is not limited to supplying power to the house 100. Power can be supplied to an electric car when the battery 101 is provided with a means for electrical connection.

### Embodiment 2

In this embodiment, an example in which maintenance is performed in the battery leasing system described in Embodiment 1 is described below.

As an example of the maintenance for extending the lifetime of the lithium-ion secondary battery, a current reverse to a charging current is supplied only momentarily (longer than or equal to 0.1 second and shorter than or equal to 3 minutes, typically longer than or equal to 3 seconds and shorter than or equal to 30 seconds) once, or more than once, in charging. Supplying a current reverse to a charging current momentarily in this manner is referred to as “supplying an inversion pulse current”.

A method for supplying an inversion pulse current will be described.

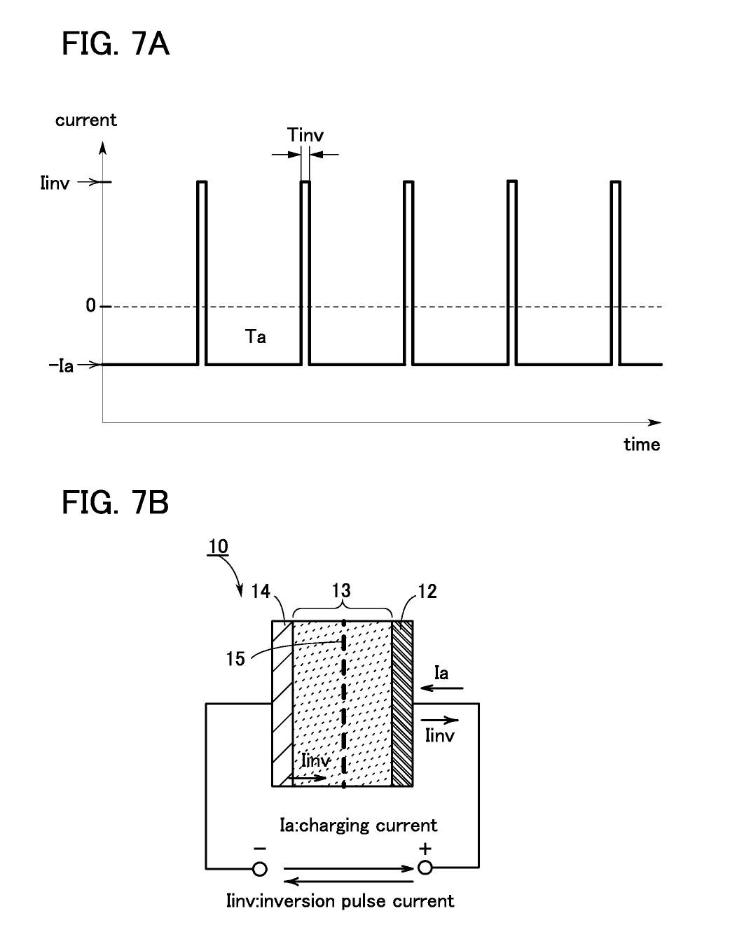

An inversion pulse current will be described with reference to FIGS. 7A and 7B. FIG. 7A is a graph schematically showing changes over time of current supplied to a positive electrode or a negative electrode of a battery 10 in charging or discharging the battery 10. A current Ia corresponds to a charging current when the battery 10 is charged, and corresponds to a discharging current when the battery 10 is discharged. In this embodiment, Ia is a constant current for simplicity; however, the amount of Ia may be varied depending on the condition of the battery 10. Although an inversion pulse current Iinv is also a constant current like Ia, the amount of inversion pulse current Iinv may be varied depending on the condition of the battery 10. In addition, the direction in which the inversion pulse current Iinv flows is defined as the positive direction of current in some cases. In such a case, since the inversion pulse current Iinv at the time of charging and the inversion pulse current Iinv at the time of discharging flow in opposite directions, the directions of the reference current at the time of charging and the reference current at the time of discharging are opposite to each other. Therefore, in charging and in discharging, the inversion pulse current values are positive values (Iinv), and the charging current value or the discharging current value is a negative value (−Ia).

For easy understanding of this embodiment, charge will be described first. FIG. 7B illustrates the charging current Ia and the inversion pulse current Iinv supplied to the battery 10 in charging. Provided that the charging current Ia and the inversion pulse current Iinv flow in opposite directions, the current value of the inversion pulse current is a positive value (Iinv), and the current value of the charging current is also a positive value (Ia).

In the battery 10, a reference numeral 12 denotes a positive electrode, 13 denotes an electrolytic solution, 14 denotes a negative electrode, and 15 denotes a separator.

As illustrated in FIG. 7B, in charging the battery 10, the charging current Ia flows in the direction from the negative electrode 14 to the positive electrode 12 outside the battery 10, and flows in the direction from the positive electrode 12 to the negative electrode 14 inside the battery 10; thus, the inversion pulse current Iinv is supplied to the negative electrode 14 or the positive electrode 12 so that the current flows in the direction from the positive electrode 12 to the negative electrode 14 outside the battery 10, and flows in the direction from the negative electrode 14 to the positive electrode 12 inside the battery 10. In the case of FIG. 7B, in charging, the current Ia is supplied to the positive electrode 12 from outside of the battery 10, and the inversion pulse current Iinv is supplied to outside of the battery 10 from the positive electrode 12.

As for supply of current, a current can be supplied to the battery 10 from a supply source for supplying power such as a current or a voltage that exists outside the battery 10, or a current can be supplied to a load including a passive element such as a resistor or a capacitor and an active element such as a transistor or a diode from the battery 10 serving as a supply source. The case where the battery 10 is a power supply source and supplies a current to such a load corresponds to the case of discharging the battery 10. Thus, the inversion pulse current Iinv at the time of charging the battery 10 corresponds to a current in the case of discharging the battery 10, and the inversion pulse current Iinv at the time of discharging the battery 10 corresponds to a current in the case of charging the battery 10.

As shown in FIG. 7A, in charging (discharging), the inversion pulse current Iinv is supplied to the positive electrode 12 or the negative electrode 14 repeatedly more than once in a period during which the charging (discharging) current Ia is supplied to the positive electrode 12 or the negative electrode 14. A time for one inversion pulse current supply Tinv is set to shorter than a time for current Ia supply Ta. The time Tinv is set in consideration of a charge rate, a discharge rate, or the like.

The time for one inversion pulse current supply Tinv should be, for example, longer than or equal to one hundreds of the time for one current Ia supply Ta and shorter than or equal to one third of the time Ta. Specifically, given that Tinv is shorter than Ta, the time Tinv is preferably longer than or equal to 0.1 second and shorter than or equal to 3 minutes, typically longer than or equal to 3 seconds and shorter than or equal to 30 seconds.

FIG. 7A shows an example where the value (absolute value) of the inversion pulse current Iinv is greater than the value (absolute value) of the current Ia. In this embodiment, the value of the inversion pulse current Iinv can be less than or equal to the value of the current Ia as long as the inversion pulse current flows between the positive electrode and the negative electrode more than once in a period during which the current Ia is supplied.

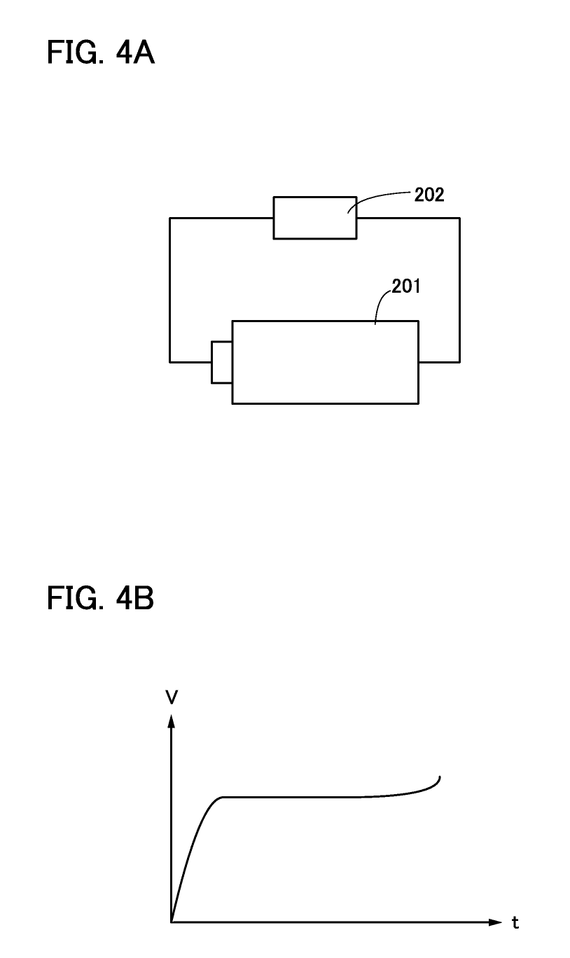

Here, description is made on the principle of operation of the lithium-ion secondary battery and the principle of lithium deposition with reference to FIGS. 4A and 4B, FIGS. 5A and 5B, and FIG. 6.

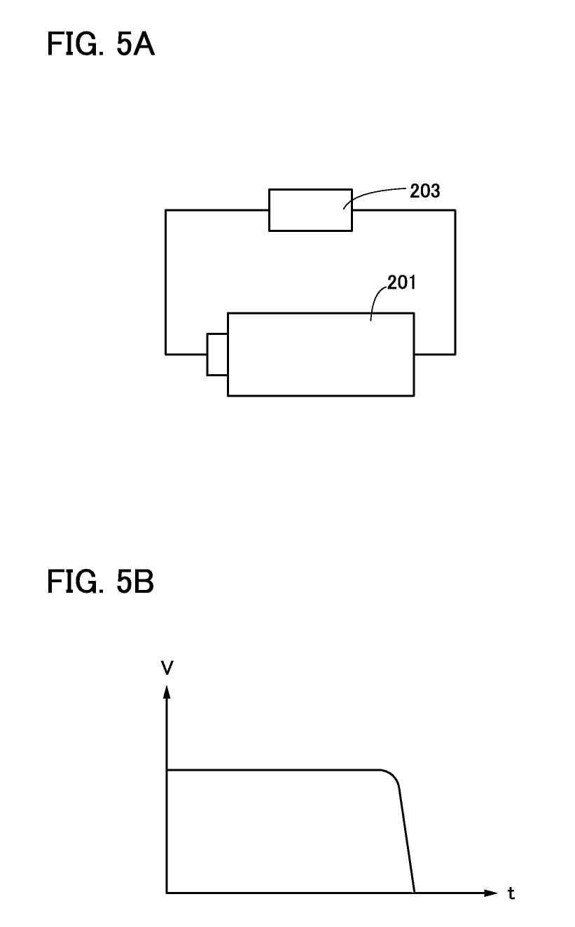

FIGS. 4A and 4B show the case of charging the lithium-ion secondary battery, and FIGS. 5A and 5B show the case of discharging the lithium-ion secondary battery. As illustrated in FIGS. 4A and 4B and FIGS. 5A and 5B, when a battery using lithium is regarded as a closed circuit, lithium ions move and a current flows in the same direction. Further, in the lithium-ion secondary battery, an anode and a cathode change places in charge and discharge, and an oxidation reaction and a reduction reaction occur on the corresponding sides; hence, an electrode with a high redox potential is called a positive electrode and an electrode with a low redox potential is called a negative electrode in this specification. For this reason, in this specification, the positive electrode is referred to as a “positive electrode” and the negative electrode is referred to as a “negative electrode” in all the cases where charge is performed, discharge is performed, an inversion pulse current is supplied, a discharging current is supplied, and a charging current is supplied. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the terms “anode” or “cathode” is used, whether it is at the time of charging or discharging is noted and whether it corresponds to a positive electrode or a negative electrode is also noted. In FIGS. 4A and 4B and FIGS. 5A and 5B, a positive electrode includes lithium iron phosphate (LiFePO₄) as a positive electrode active material, and a negative electrode includes graphite as a negative electrode active material.

The lithium iron phosphate (LiFePO₄) is preferably used as the positive electrode of the battery of the battery leasing system because of having high safety. Further, the use of one or more of ionic liquids (room temperature ionic liquids) that has non-flammability and non-volatility as the solvent for the electrolytic solution can prevent a battery from exploding or catching fire even when the battery internally shorts out or the internal temperature increases due to overcharging or the like, so that the safety of the battery can be increased.

FIG. 4A illustrates a lithium-ion secondary battery 501 and a charger 502 in the case of charging the lithium-ion secondary battery. When the lithium-ion secondary battery is charged, a reaction expressed by Formula (1) occurs in the positive electrode.

LiFePO₄→FePO₄+Li⁺+e⁻ (1)

A reaction of Formula (2) occurs at a negative electrode.

C₆+Li⁺+e⁻→LiC₆ (2)

Thus, the overall reaction in charging the lithium-ion secondary battery is expressed by Formula (3).

LiFePO₄+C₆→FePO₄+LiC₆ (3)

When the battery is charged, in general, lithium is stored in graphite in the negative electrode; however, in the case where deposition of a lithium metal occurs at the negative electrode for any cause, a reaction expressed by Formula (4) occurs. That is, both a reaction of lithium intercalation into graphite and a lithium deposition reaction occur at the negative electrode.

Li⁺+e⁻→Li (4)

The equilibrium potentials of the positive electrode and the negative electrode are determined by a material and an equilibrium state of the material. The potential difference (voltage) between the electrodes varies depending on the equilibrium states of the materials of the positive electrode and the negative electrode.

FIG. 4B shows a voltage at the time of charging the lithium-ion secondary battery. As shown in FIG. 4B, in charging, as a reaction proceeds due to a current which flows over time t, the voltage between the electrodes increases.

FIG. 5A illustrates the lithium-ion secondary battery 501 and a load 503 in the case of discharging the lithium-ion secondary battery. When the lithium-ion secondary battery is discharged, a reaction expressed by Formula (5) occurs in the positive electrode.

FePO₄+Li⁺+e⁻LiFePO₄ (5)

In addition, a reaction expressed by Formula (6) occurs in the negative electrode.

LiC₆→C₆+Li⁺+e⁻ (6)

Thus, the overall reaction in discharging the lithium-ion secondary battery is expressed by Formula (7).

FePO₄+LiC₆→LiFePO₄+C₆ (7)

In addition, in discharge performed after the lithium metal is deposited, a reaction expressed by Formula (8) occurs in the negative electrode. That is, both a reaction of lithium deintercalation from graphite and a lithium dissolution reaction occur at the negative electrode.

Li→Li⁺+e⁻ (8)

FIG. 5B shows a voltage at the time of discharging the lithium-ion secondary battery. As shown in FIG. 5B, in discharging, as a reaction proceeds due to a current which flows over time t, the voltage between the electrodes decreases.

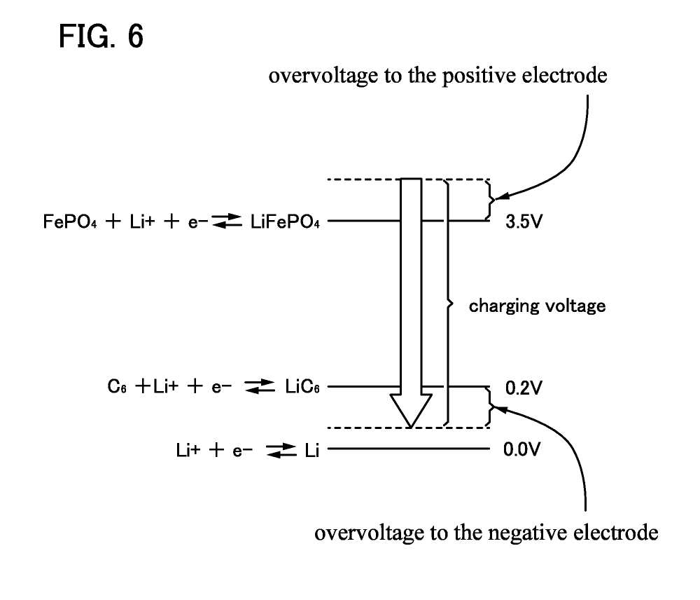

FIG. 6 illustrates the relation between the electrode potential of a positive electrode including lithium iron phosphate and the electrode potential of an electrode including a lithium metal, and the relation between the electrode potential of a negative electrode including graphite and the electrode potential of the electrode including a lithium metal. In FIG. 6, the hollow arrow represents a charging voltage.

The electrode potential difference between the positive electrode including lithium iron phosphate and the negative electrode including graphite is as follows: 3.5 V−0.2 V=3.3 V. Since the electrode potentials are determined by the equilibrium states, at a charging voltage of 3.3 V, the reaction of Formula (1) and the reaction of Formula (5) equilibrate in the positive electrode and the reaction of Formula (2) and the reaction of Formula (6) equilibrate in the negative electrode; thus, a current does not flow.

For this reason, a charging voltage higher than 3.3 V is required to supply a charging current. For example, on the assumption that a series resistance component inside the battery is ignored and all extra charging voltage is used in the electrode reactions of Formulae (1) and (2), as indicated by the hollow arrow in FIG. 6, the extra charging voltage is shared by the positive electrode and the negative electrode as an overvoltage to the positive electrode and an overvoltage to the negative electrode. In order to obtain a higher current density per unit electrode area, a higher overvoltage is needed. For example, when quick charge is performed on the battery, a current density per unit surface area of an active material needs to be high, in which case a higher overvoltage is required.

However, as the overvoltage is raised to increase the current density per unit surface area of the active material, the overvoltage to the negative electrode increases; therefore, the tip of the hollow arrow in FIG. 6 becomes lower than the electrode potential of the electrode including the lithium metal. Then, the reaction of Formula (4) occurs. At this time, lithium is deposited on the surface of the negative electrode.

When lithium is deposited, a positive electrode and a negative electrode might be short-circuited; however, supply of an inversion pulse current during charge can reduce the lithium deposition and can desirably dissolve a deposit, resulting in increase in the reliability of a battery.

In the battery leasing system, a maintenance staff member from the leasing company performs maintenance on the battery. In the maintenance, an inversion pulse current is supplied to the battery installed at the user's home once every year or every several years from the time at which the battery is lent to the user. The cost of the maintenance may be charged to the user separately. In order to diffuse many batteries, the leasing company preferably bears the maintenance cost. When there are many battery users in the same area, the maintenance can be collectively performed, in which case the leasing company can perform the maintenance at lower cost.

Another advantageous effect of the battery leasing system is to eliminate the need for monitoring the battery continuously, because the long lifetime and high safety of the battery is ensured by the maintenance described in this embodiment. The continuous monitoring of the battery requires installation of additional equipment such as a communication wire for the monitoring and extra power for the monitoring. Further, the continuous monitoring requires staff members who monitor the battery in case of trouble with the battery during the monitoring, resulting in high cost. Specifically, in order to monitor batteries for 24 hours, three or more staff members are needed to monitor the batteries on a rotating basis because of an issue with working hours, regardless of the number of batteries to be monitored. This leads to increase in cost. Further, the batteries are monitored for 24 hours throughout a year. It can be said that the use of power for monitoring batteries is a waste of energy.

Further, with the battery leasing system including the maintenance described in this embodiment, the battery can be reused for a long period of time, which eliminates the need for destroying the battery or decomposing the battery to be recycled. Thus, the battery leasing system can contribute to the conservation of environment by preventing the destruction and the decomposition of the battery and allowing the battery to be reused.

Furthermore, the battery leasing system including the maintenance described in this embodiment can promote the installation of batteries in homes.

This application is based on Japanese Patent Application serial no. 2013-046500 filed with Japan Patent Office on Mar. 8, 2013, the entire contents of which are hereby incorporated by reference.

What is claimed is:

1. A system for leasing a battery, in which a user has a supply of electric power from an electric power company at unit prices of electric power that are different between a first time period and a second time period, comprising:
in the second time period in which a unit price of electric power is lower than a unit price of electric power in the first time period, charging the battery by electric power supplied from the electric power company,
allowing the user to consume electric power supplied only from the battery in the first time period,
calculating a difference between a predicted first electricity charge for a case where the battery leasing system is not employed and a second electricity charge that is actually paid to the electric power company by the user,
calculating a charge that is commensurate with the leasing company, from the difference between the first electricity charge and the second electricity charge, and
requesting the user to pay the charge to the leasing company.

2. The system for leasing a battery, according to claim 1, wherein the battery is a lithium-ion secondary battery.

3. A system for leasing a battery, in which a user has a supply of electric power from an electric power company at unit prices of electric power that are different between a first time period and a second time period, comprising:
in the second time period in which a unit price of electric power is lower than a unit price of electric power in the first time period, charging the battery by electric power supplied from the electric power company,
allowing the user to consume electric power supplied only from the battery in the first time period,
calculating a difference between a predicted first electricity charge for a case where the battery leasing system is not employed and a second electricity charge that is actually paid to the electric power company by the user,
calculating a first charge that is commensurate with the leasing company, from the difference between the first electricity charge and the second electricity charge,
performing a maintenance on the battery by the leasing company,
calculating a second charge that is commensurate with the leasing company, and
requesting the user to pay the first charge and the second charge to the leasing company.

4. The system for leasing a battery, according to claim 3,
wherein, as the maintenance, a current reverse to a charging current is supplied to the battery once or more than once in charging the battery.

5. The system for leasing a battery, according to claim 3,
wherein the battery is a lithium-ion secondary battery.
